(19) United States
(12) Patent Application Publication
(10) Pub. No.: US 2011/0043104 A1
(43) Pub. Date: Feb. 24, 2011

(54) Electroluminescence (EL) Device and Method for the Production Thereof

(75) Inventors: Emil Enz, Gais (CH); Heidi Knechtli, Rheineck (CH)

Correspondence Address: THE WEBB LAW FIRM, P.C., 700 KOPPERS BUILDING, 436 SEVENTH AVENUE, PITTSBURGH, PA, 15219, US

(73) Assignee: SST SMART SURFACE TECHNOLOGY AG, Gais (CH)

(21) Appl. No.: 12/867,370

(22) PCT Filed: Jan. 22, 2009
(86) PCT No.: PCT/CH09/00027

§ 371 Date: Oct. 20, 2010

(30) Foreign Application Priority Data
Feb. 18, 2008 (CH) 233/08

(51) Int. Cl. H01J 1/62; H01J 9/00

(52) U.S. Cl. 313/505; 445/24

(57) ABSTRACT

An electroluminescence (EL) device includes a planar electroluminescence (EL) layer, on the rear of which two segment electrodes are disposed insulated next to and nested inside each other in an electrode plane and can be connected to an alternating current source, and on the front of which at least one transparent front electrode, particularly in the form of one or more graphical elements, are disposed in an insulated manner. In such an EL device, luminosity that is practically independent of the shape of the counter-electrodes and uniform across the surface is provided, and a formation of the graphical elements by simple cutting out or stamping out is enabled, in that the nesting of the segment electrodes is configured such that the segment electrodes are alternately disposed in two independent directions of the electrode plane.

The invention is concerned with the field of lighting technology. It relates to an electroluminescence (EL) device in accordance with the preamble of claim 1. The invention furthermore relates to a method for producing such an EL device.

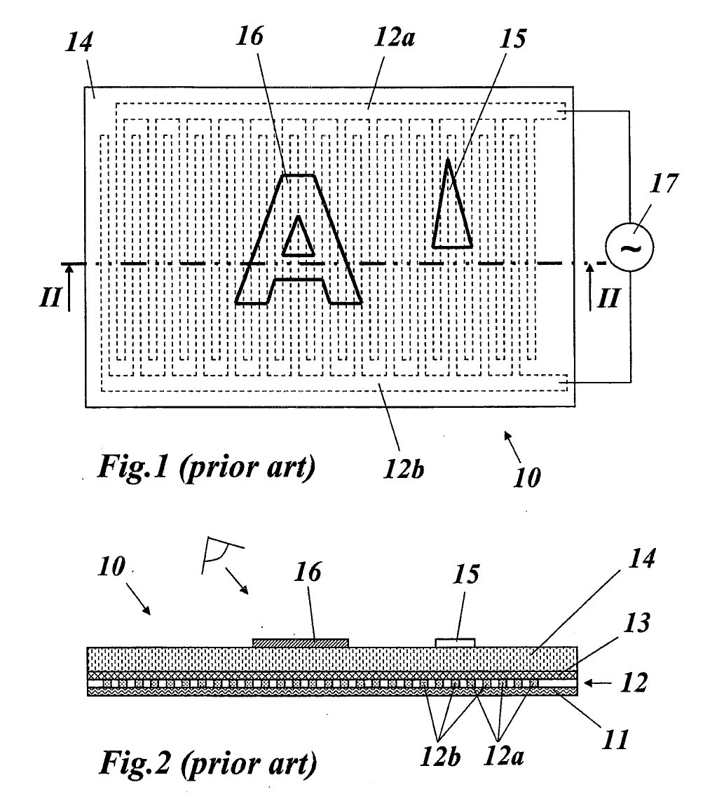

It has already been known for a relatively long time, for the purpose of providing arbitrary illuminated graphical elements, to construct specific electro-luminescence (EL) devices in which the active electrodes, to which an AC voltage is applied, are arranged in a distributed fashion and in a manner interlaced in one another on the rear side of an EL layer, while the graphical elements that can be illuminated are fitted as (passive) front electrodes or counterelectrodes on the front side of the EL layer (JP-A-8153582 or EP-A1-1 397 027). The construction of such a known EL device is illustrated in FIGS. 1 and 2.

The known EL device 10 in FIGS. 1 and 2 comprises a central EL layer 14, which can be excited to emit light by means of a suitable alternating electric field in a manner known per se. The alternating electric field is generated by means of an AC voltage source 17, e.g. by inversion and transformation of a battery voltage, the output voltage of which is applied to an electrode arrangement 12. The electrode arrangement 12 is applied—in a manner insulated from the EL layer 14 by an insulating layer 13—on the rear side of the EL layer 14 on a base layer 11. The graphical elements in the form of (passive) transparent counterelectrodes 15, 16 are arranged on the front side of the EL layer 14.

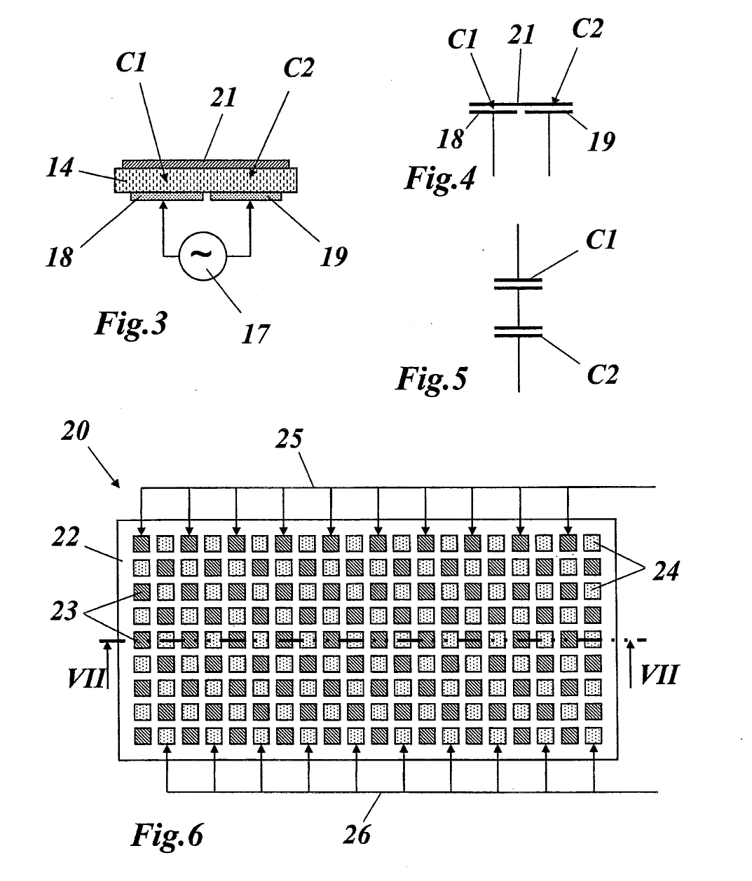

The electrode arrangement 12 consists of two intermeshing electrode combs 12a and 12b, which are represented by dashed lines in FIG. 1. Between those regions of the electrode combs 12a, 12b which are covered by the counterelectrodes 15, 16 and the counterelectrodes 15, 16, an alternating electric field is established when the AC voltage source 17 is applied to the electrode combs 12a, 12b in accordance with FIG. 1, said alternating electric field exciting only the regions of the EL layer 14 below the counterelectrodes 15, 16 to emit light. As is illustrated in the basic illustration in FIGS. 3-5, each of the control electrodes 18, 19, which correspond to the electrode combs 12a, 12b, forms together with the counterelectrode 21 (corresponds to the counterelectrodes 15, 16) a capacitance C1 and C2 respectively. The two capacitances C1, C2 are connected in series, which leads to the AC voltage being divided between the capacitances C1, C2. If the output voltage of the AC voltage source 17 is designated by U_{AC}, it holds true that U_{AC}=U_{C1}+U_{C2}, where U_{C1} and U_{C2} are the voltages across the capacitances C1 and C2.

With thickness and layer structure remaining constant over the area of the EL device 10, the size of the capacitances C1 and C2 (apart from edge effects), substantially depends on the respective total area of the two control electrodes 18, 19 or 12a, 12b which is covered by the counterelectrode 21 or 15, 16. If the counterelectrode has a large area and is wide—as is the case for the counterelectrode 16—the covered total areas of both control electrodes 12a, 12b are approximately identical owing to the alternative comb structure. Accordingly, the capacitances C1 and C2 and the AC voltages U_{C1} and U_{C2} dropped across them are also approximately identical, which—apart from the line structure caused by the electrode interspaces—leads to an approximately identical luminous intensity of the excited EL layer 14 in the regions of the two electrodes 12a, 12b.

However, the uniformity of the luminous intensity in the area is not always provided: if the graphical element has the form of the counterelectrode 15, for example, that is to say is a narrow structure that tapers parallel to the teeth of the electrode combs 12a, 12b, the covered total areas of the electrode combs 12a, 12b have very different sizes, which leads to capacitances C1 and C2 of different sizes and corresponding differences in the luminous intensity, which are generally undesirable.

A further disadvantage results from the intermeshing comb structure of the electrode combs 12a, 12b as such: since the AC voltage has to be passed on opposite sides of the EL device 10 via a common supply line running along the edge to the teeth of the electrode combs 12a, 12b, the area of the EL device 10 cannot be reduced subsequently by means of cutting out or the like, to the size of the actual graphical element, because otherwise the contact-making on the edge side is lost. Therefore, the EL device cannot be produced in strip form and then correspondingly cut to size in order to form the desired graphical elements.

Therefore, it is an object of the invention to provide an EL device which avoids the disadvantages of the known devices and, in particular, provides a luminous intensity that is practically independent of the form of the counterelectrodes and is uniform over the area, and which enables the graphical elements to be shaped by means of simple cutting out or stamping out, and also to specify a method for producing the device.

The object is achieved by means of the totality of the features of claims 1 and 11. What is essential to the invention is that the interlacing of the segment electrodes is embodied in such a way that the segment electrodes are arranged in an alternating fashion in two independent directions in the electrode plane. As a result of the two-dimensional raster pattern of the segment electrodes, it is possible, even on small and specifically shaped partial areas of the device, to have the effect that the covered segment electrode areas are substantially identical in area, such that a luminous intensity that is uniform over the area is established in virtually all cases. Furthermore, the two-dimensional raster pattern enables contact-making which extends right into the individual electrode elements and which enables the device to be cut to size in any desired manner.

A first configuration of the EL device according to the invention is characterized in that the two segment electrodes are embodied such that they are of identical type. This is the case for a checkered arrangement of the segment electrodes, for example. In this case, the two segment electrodes, in particular, each comprise a multiplicity of electrode elements in the form of a regular polygon, in particular of a square or hexagon.

Another configuration of the EL device according to the invention is characterized in that one segment electrode is embodied as a multiple connected area in which cutouts are provided in a manner distributed uniformly over the area, and in that the other segment electrode comprises a multiplicity of separate electrode elements arranged in the cutouts. No specific contact-making needs to be provided here for the multiply connected segment electrode. Preferably, the cutouts of one segment electrode and the electrode elements of the other segment electrode are in each case embodied in a circular fashion, where a ring-shaped insulating region is in each case arranged between one segment electrode and the electrode elements of the other segment electrode.

In this case, particularly simple contact-making is achieved by virtue of the fact that the cutouts of one segment electrode and the electrode elements of the other segment electrode are arranged on the crossing points of an imaginary, in particular square, grid, and in that the electrode elements of the other segment electrode are contact-connected and electrically connected to one another by a contact-making grid corresponding to the imaginary grid.

Preferably, an insulating layer is arranged above the segment electrodes, said insulating layer having cutouts at the locations which correspond to the electrode elements of the other segment electrode, the cutouts each leaving free at least one central region of said electrode elements, and in that the contact-making grid is arranged on the insulating layer in such a way that the crossing points of the contact-making grid make contact with the electrode elements of the other segment electrode in each case in the free central region.

Another EL device according to the invention is distinguished by the fact that the areas of the two segment electrodes that are covered by the transparent front electrode are substantially identical. It is particularly expedient if the two segment electrodes are embodied and arranged in a manner interlaced in each other in such a way that, in an arbitrary partial area in the electrode plane, the total areas of the two segment electrodes that are situated in the partial area are substantially identical.

The method according to the invention is characterized in that, in a first step, an EL device having a, preferably rectangular, base area is produced, and in that, in a second step, the graphically configured EL device is cut out or stamped out from said base area, where the cutting out can be effected by means of laser technology.

The invention will be explained in greater detail below on the basis of exemplary embodiments in association with the drawing, in which:

FIG. 1 shows, in the plan view from above, an EL device according to the prior art with intermeshing electrode combs on the rear side of the EL layer;

FIG. 2 shows the section through the EL device in accordance with FIG. 1 in the plane II-II;

FIG. 3 shows the basic schematic diagram of the device from FIG. 1;

FIGS. 4 and 5 show the electrical equivalent circuit diagram derived from the basic schematic diagram in FIG. 3;

FIG. 6 shows a checkered arrangement of the rear-side segment electrodes in accordance with a first exemplary embodiment of the invention;

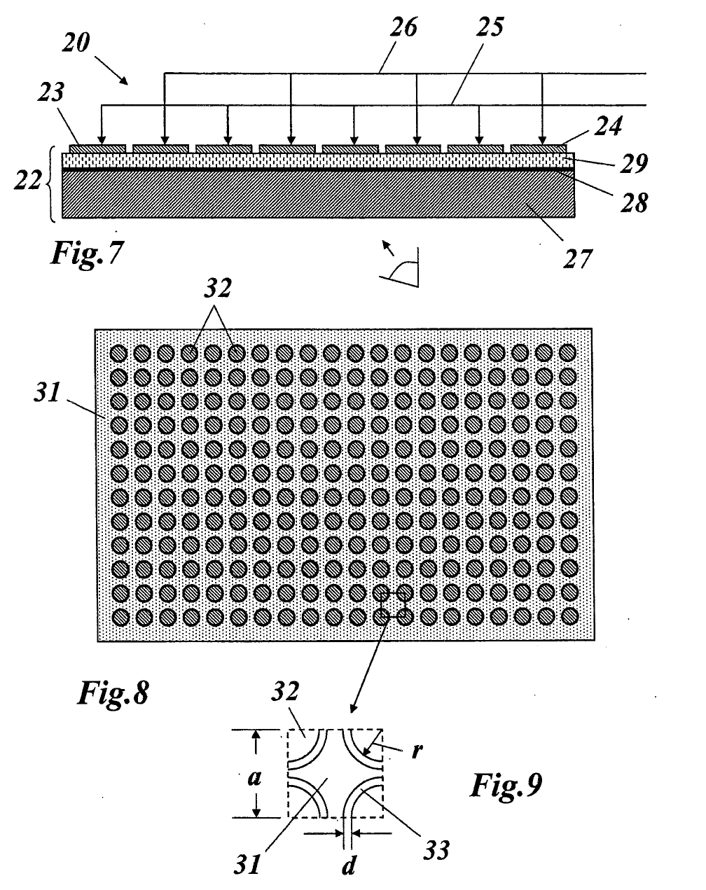

FIG. 7 shows the section through the device in accordance with FIG. 6 in the plane VII-VII;

FIG. 8 shows an arrangement of the rear-side segment electrodes in accordance with a second exemplary embodiment of the invention, where individual electrode elements of one segment electrode are enclosed by a multiply connected area of the other segment electrode;

FIG. 9 shows an excerpt from the electrode area in accordance with FIG. 8;

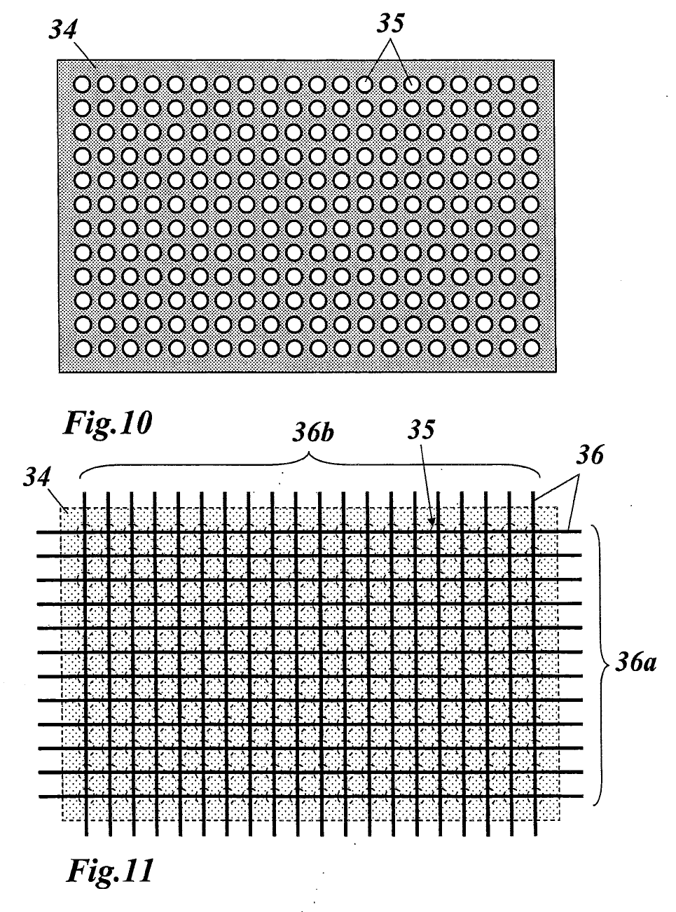

FIG. 10 shows the configuration of the insulating layer associated with FIG. 8, which is used for making contact with the individual electrode elements;

FIG. 11 shows the contact-making grid used for making contact with the individual electrode elements from FIG. 8; and

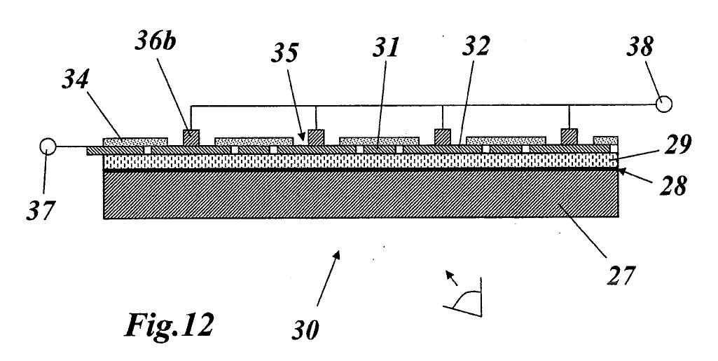

FIG. 12 shows in section an EL device with the electrode structure in accordance with FIG. 8.

An essential building block for an EL device according to the invention is a two-dimensional periodicity of the electrode arrangement on the rear side of the EL layer. FIG. 6 illustrates an exemplary embodiment of such a two-dimensional periodicity. The EL device 20 in FIG. 6 has a checkered arrangement of (square) electrode elements of a first segment electrode 23 and of a second segment electrode 24 on the rear side of a layer arrangement 22 having an EL layer 29 (FIG. 7). The electrode elements of the segment electrode 23 can be connected to an AC voltage source (17) via a first contact-making arrangement 25, and the electrode elements 24 of the second segment electrode 24 can be correspondingly connected via a second contact-making arrangement 26. The contact-making arrangements 25 and 26 are merely indicated schematically in FIG. 6, but can be realized by two diagonally disposed crossed grids of the type shown in FIG. 11 which are arranged in an insulated fashion one above the other and are offset relative to each other (rotated by 45°).

In accordance with FIG. 7, on the front side of the EL layer 29, a transparent front electrode 28 lies opposite the electrode arrangement 23, 24, contact not being made with said front electrode. EL layer 29 and front electrode 28 are arranged on a carrier film 27 as base layer. If the EL layer is electrically insulating, the electrodes 23, 24 and 28 can lie directly on the EL layer 29. Otherwise, an insulating layer additionally has to be placed between them.

If the contact-making grids analogously to FIG. 11 have a sufficiently high electrical conductivity in the rows and columns, they can be connected to the AC voltage source at one location. The EL device 20 can then be cut to size in order to form a graphical element (lettering or the like) without the contact-making of individual electrode elements 23, 24 being lost. If the subdivision of the area into the individual squares of the segment electrodes 23, 24 is fine enough (in the millimeters range), this gives rise, for virtually arbitrary (cut-out) partial areas of the EL device 20, to substantial identity in the remaining total areas of the segment electrodes 23 and 24.

Another, particularly preferred exemplary embodiment of the EL device with an electrode arrangement having two-dimensional periodicity (in the x- and y-directions) is represented in FIGS. 8 to 12. The rear electrode arrangement of the EL device 30 having the two segment electrodes 31 and 32 has the configuration illustrated in FIG. 8: one segment electrode 31 is embodied as a multiply connected area which is provided with circular cutouts on the crossing points of an imaginary square grid. The circular electrode elements of the other segment electrode 32 are arranged in said cutouts—in a manner electrically isolated by a ring-shaped insulating region (33 in FIG. 9). The area element illustrated in an enlarged fashion in FIG. 9 can be cut out from the area, said area element periodically repeating in the x- and y-directions.

The area of the segment electrode 32 in this area element is π·r², and the area of the segment electrode 31 is a²−π(r+d)², where a is the period length, r is the radius of a circular electrode element of the segment electrode 32, and d is the width of the insulating region 33. Both areas should ideally be identical in order to obtain a luminous intensity that is as uniform as possible in the area. If the width d is disregarded, the following arises from this condition: a=\sqrt{2π·r}.

Since the segment electrode 31 as a multiply connected area surrounds and encloses the separate electrode elements of the other segment electrode 32, contact can be made with the segment electrode at the edge in a very simple manner in order to provide a connection 37 for the AC voltage source 17 (FIG. 12). By contrast, a square contact-making grid 36 consisting of rows 36a and columns 36b in accordance with FIG. 11 is provided for making contact with the insular electrode elements of the other segment electrode 32. Firstly, an insulating layer 34 in accordance with FIG. 10 is applied over the electrode arrangement in accordance with FIG. 8, said insulating layer having cutouts 35 which in each case leave free a central region of the electrode elements of the segment electrode 32. The contact-making grid 36 is then placed over the insulating layer 34 in such a way that the crossing points of the contact-making grid 36 or 36a, b make contact with the electrode elements of the other segment electrode 32 in each case in the free central region (FIG. 11). The contact-making grid 36 can then be connected to the AC voltage source 17 at different locations, as a result of which all electrode elements of the segment electrode 32 that are present (still after the trimming of the EL device 30) are automatically connected.

Materials known to the person skilled in the art are used for the EL layer 29, the insulating layer 34 and the carrier film 27. In particular, it is possible to use printing techniques for applying the conductive and nonconductive layers. The EL device 20 or 30 can firstly be produced in the form of a strip having a constant width. Lettering or some other graphical element can then be cut out from said strip by means of a stamping or cutting process. Connection areas at which the contact-making grid 36 and the segment electrode 31 can be connected to connections 37 and 38 should be left in the process. In this case, a laser cutting method can advantageously be used for cutting.

### LIST OF REFERENCE SYMBOLS

EL device
Base layer
Electrode arrangement
12a, 12b Electrode comb
Insulating layer
EL layer
15, 16 Counterelectrode (transparent; graphical element)
17 AC voltage source
18, 19 Control electrode
20, 30 EL device
21 Counterelectrode (graphical element)
22 Layer structure
23, 24 Segment electrode
25, 26 Contact-making arrangement
27 Carrier film
28 Front electrode (transparent)
29 EL layer
31, 32 Segment electrode
33 Insulating region (ring-shaped)
34 Insulating layer
35 Cutout
36 Contact-making grid
36a Row
36b Column
37, 38 Connection
a Distance (segment electrodes 32)
C1, C2 Capacitance
d Width (insulation region)
r Radius (segment electrode 32)

1. An electroluminescence (EL) device comprising a planar electroluminescence (EL) layer, on the rear side of which two rear electrodes are arranged in an insulated fashion alongside each other and in a manner interlaced in each other in an electrode plane and on the front side of which at least one transparent front electrode, in the form of one or more graphical elements, is arranged in an insulated fashion, wherein the interlacing of the rear electrodes is embodied in such a way that the rear electrodes are arranged in an alternating fashion in two independent directions in the electrode plane, at least one of the rear electrodes comprising a multiplicity of separate electrode elements with which contact is made individually.

2. The EL device as claimed in claim 1, wherein the two rear electrodes are embodied such that they are of identical type.

3. The EL device as claimed in claim 2, wherein the two rear electrodes each comprise a multiplicity of electrode elements in the form of a regular polygon.

4. The EL device as claimed in claim 1, wherein one rear electrode is embodied as a multiple connected area in which cutouts are provided in a manner distributed uniformly over the area, and in that the other rear electrode comprises a multiplicity of separate electrode elements arranged in the cutouts.

5. The EL device as claimed in claim 4, wherein the cutouts of one rear electrode and the electrode elements of the other rear electrode are in each case embodied in a circular fashion.

6. The EL device as claimed in claim 5, wherein a ring-shaped insulating region is arranged between one rear electrode and the electrode elements of the other rear electrode.

7. The EL device as claimed in claim 4, wherein the cutouts of one rear electrode and the electrode elements of the other rear electrode are arranged on the crossing points of an imaginary grid, and the electrode elements of the other rear electrode are contact-connected and electrically connected to one another by a contact-making grid corresponding to the imaginary grid.

8. The EL device as claimed in claim 7, wherein an insulating layer is arranged above the rear electrodes, said insulating layer having cutouts at the locations which correspond to the electrode elements of the other rear electrode, the cutouts each leaving free at least one central region of said electrode elements, and the contact-making grid is arranged on the insulating layer in such a way that the crossing points of the contact-making grid make contact with the electrode elements of the other rear electrode in each case in the free central region.

9. The EL device as claimed in claim 1, wherein the areas of the two rear electrodes that are covered by the transparent front electrode are substantially identical.

10. The EL device as claimed in claim 1, wherein the two rear electrodes are embodied and arranged in a manner interlaced in each other in such a way that, in an arbitrary partial area in the electrode plane, the total areas of the two rear electrodes that are situated in the partial area are substantially identical.

11. A method for producing a graphically configured EL device, provided with one or more graphical elements, as claimed in claim 1, comprising:
(a) producing an EL device having a rectangular base area; and
(b) cutting out or stamping said EL device from the base area.

12. The method as claimed in claim 11, wherein the cutting out is effected by means of laser technology.

13. The EL device as claimed in claim 5, wherein the cutouts of one rear electrode and the electrode elements of the other rear electrode are arranged on the crossing points of an imaginary grid, and the electrode elements of the other rear electrode are contact-connected and electrically connected to one another by a contact-making grid corresponding to the imaginary grid.

14. The EL device as claimed in claim 6, wherein the cutouts of one rear electrode and the electrode elements of the other rear electrode are arranged on the crossing points of an imaginary grid, and the electrode elements of the other rear electrode are contact-connected and electrically connected to one another by a contact-making grid corresponding to the imaginary grid.
